(19) United States
(12) Patent Application Publication
(10) Pub. No.: US 2025/0184545 A1
(43) Pub. Date: Jun. 5, 2025

(54) INTERACTIVE LIVE STREAMING METHOD, APPARATUS, ELECTRONIC DEVICE, AND STORAGE MEDIUM

(71) Applicant: DOUYIN VISION (BEIJING) CO., LTD., Shijingshan District, Beijing (CN)

(72) Inventors: Yixu WANG, Beijing (CN); Yingjie RONG, Beijing (CN); Xiaozhou CAO, Beijing (CN)

(21) Appl. No.: 18/862,050

(22) PCT Filed: Jun. 16, 2023
(86) PCT No.: PCT/CN2023/100636

§ 371 Date: Oct. 31, 2024

(30) Foreign Application Priority Data
Jun. 16, 2022 (CN) 202210689076.4

(51) Int. Cl. H04N 21/2187; H04N 21/6437

(52) U.S. Cl. CPC H04N 21/2187; H04N 21/6437

(57) ABSTRACT

The present disclosure relates to an interactive live streaming method applicable to a first client, comprising: receiving an invite message sent from a second client, wherein the invite message is configured to invite the first client to establish an interactive live streaming; and sending a Real Time Communication (RTC) reply message to the second client according to the invite message, wherein the RTC reply message is configured to indicate an agreement to establish the interactive live streaming with the second client, and is for the second client to establish the interactive live streaming with the first client according to the RTC reply message.

### CROSS-REFERENCE TO RELATED APPLICATIONS

The present disclosure is a U.S. National Stage Application under 35 U.S.C. § 371 of International Patent Application No. PCT/CN2023/100636, filed on Jun. 16, 2023, which is based on and claims priority of Chinese application for invention No. 202210689076.4, filed on Jun. 16, 2022, the disclosures of both of which are hereby incorporated into this disclosure by reference in its entirety.

### TECHNICAL FIELD

The present disclosure relates to the technical field of livestreaming, in particular to an interactive live streaming method and apparatus, an electronic device, and a storage medium.

### BACKGROUND

At present, with a development of live streaming (live broadcasting) technology, a form of live streaming has emerged that allows two anchors to connected and interact with each other and broadcast together, making images and sounds (co-streaming) accessible to audiences of both live channels (live streams), hereinafter referred to as interactive live streaming. The process of establishing an interactive live streaming may comprise sending an invite message from a user device A corresponding to a live channel A to a user device B corresponding to a live channel B to indicate the establishment of the interactive live streaming. Upon receiving the invite message, the user device B sends a reply message to the user device A to indicate agreement to establish the interactive live streaming. Upon receiving the reply message, the user device A establishes the interactive live streaming with user device B.

### SUMMARY

According to a first aspect of some embodiments of the present disclosure, there is provided an interactive live streaming method applicable to a first client, comprising: receiving an invite message sent from a second client, wherein the invite message is configured to invite the first client to establish an interactive live streaming; and sending a Real Time Communication (RTC) reply message to the second client according to the invite message, wherein the RTC reply message is configured to indicate an agreement to establish the interactive live streaming with the second client, and is for the second client to establish the interactive live streaming with the first client according to the RTC reply message.

In some embodiments, the sending the RTC reply message to the second client according to the invite message comprises: sending the RTC reply message to the second client in response to a remaining valid duration of the invite message being less than a first duration threshold.

In some embodiments, the sending the RTC reply message to the second client according to the invite message comprises: sending the RTC reply message and a Hypertext Transfer Protocol (HTTP) reply message to the second client according to the invite message, to enable the second client to establish an interactive live streaming with the first client based on a target reply message, wherein the target reply message is one of the RTC reply message and the HTTP reply message received first by the second client, and the HTTP reply message is configured to indicate the agreement to establish the interactive live streaming with the second client.

In some embodiments, the sending the HTTP reply message to the second client according to the invite message comprises: sending the HTTP reply message to the second client in response to a remaining valid duration of the invite message is greater than or equal to a second duration threshold, wherein the HTTP reply message is configured to indicate the agreement to establish the interactive live streaming with the second client.

According to a second aspect of some embodiments of the present disclosure, there is provided an interactive live streaming method applicable to a second client, comprising: sending an invite message to a first client, wherein the invite message is configured to invite the first client to establish an interactive live streaming; and receiving a Real Time Communication (RTC) reply message sent from the first client, wherein the RTC reply message is for the second client to establish the interactive live streaming with the first client according to the RTC reply message, and is configure to indicate that the first client agrees to establish the interactive live streaming with the second client.

In some embodiments, the method further comprises: receiving a Hypertext Transfer Protocol (HTTP) reply message sent from the first client after sending the invite message to the first client.

In some embodiments, the method further comprises: after sending the invite message to the first client, in response to receiving the RTC reply message and not establishing the interactive live streaming with the first client, establishing the interactive live streaming with the first client according to the RTC reply message.

In some embodiments, the establishing the interactive live streaming with the first client according to the RTC reply message comprises: in response to receiving the HTTP reply message and not establishing the interactive live streaming with the first client, establishing the interactive live streaming with the first client based on the HTTP reply message.

According to a third aspect of the embodiments of the present disclosure, there is provided an interactive live streaming apparatus, comprising: a receiving module and a sending module. The receiving module is configured to receive an invite message sent from a second client, wherein the invite message is configured to invite the first client to establish an interactive live streaming; and the sending module is configured to send a Real Time Communication (RTC) reply message to the second client according to the invite message, wherein the RTC reply message is configured to indicate an agreement to establish the interactive live streaming with the second client, and is for the second client to establish the interactive live streaming with the first client according to the RTC reply message.

In some embodiments, the sending module is configured to send the RTC reply message to the second client in response to a remaining valid duration of the invite message being less than a first duration threshold.

In some embodiments, the sending module is particularly configured to send the RTC reply message and a Hypertext Transfer Protocol (HTTP) reply message to the second client according to the invite message, to enable the second client to establish an interactive live streaming with the first client based on a target reply message, wherein the target reply message is one of the RTC reply message and the HTTP reply message received first by the second client, and the HTTP reply message is configured to indicate the agreement to establish the interactive live streaming with the second client.

In some embodiments, the sending module is particularly configured to send the HTTP reply message to the second client in response to a remaining valid duration of the invite message is greater than or equal to a second duration threshold. The HTTP reply message is configured to indicate the agreement to establish the interactive live streaming with the second client.

According to a fourth aspect of the embodiments of the present disclosure, there is provided an interactive live streaming apparatus, comprising: a sending module and a receiving module. The sending module is configured to send an invite message to a first client, wherein the invite message is configured to invite the first client to establish an interactive live streaming; and the receiving module is configured to receive a Real Time Communication (RTC) reply message sent from the first client, wherein the RTC reply message is for the second client to establish the interactive live streaming with the first client according to the RTC reply message, and is configure to indicate that the first client agrees to establish the interactive live streaming with the second client.

In some embodiments, the receiving module is further configure to receive a Hypertext Transfer Protocol (HTTP) reply message sent from the first client, after sending the invite message to the first client.

In some embodiments, the apparatus further comprises an establishment module. The establishment module is configured to establish the interactive live streaming with the first client according to the RTC reply message, in response to receiving the RTC reply message and not establishing the interactive live streaming with the first client.

In some embodiments, the apparatus further comprises an establishment module. The establishment module is configured to establish the interactive live streaming with the first client based on the HTTP reply message, in response to receiving the HTTP reply message and not establishing the interactive live streaming with the first client, after sending the invite message to the first client.

According to a fifth aspect of the embodiments of the present disclosure, there is provided an electronic device, comprising a processor, a memory, and a computer program stored on the memory and executable on the processor, wherein the computer program, when executed by the processor, causes the processor to implement the interactive live streaming method according to the first or second aspect.

According to a sixth aspect of the embodiments of the present disclosure, there is provided a non-transitory computer-readable storage medium stored thereon a computer program that, when executed by a processor, non-transitory implement the interactive live streaming method according to the first or second aspect.

According to a seventh aspect of the embodiments of the present disclosure, there is provided a computer program product, the computer program product comprising a computer program that, when running on a processor, causes the processor to execute the computer program to implement the interactive live streaming method according to the first or second aspect.

According to an eighth aspect of the embodiments of the present disclosure, there is provided a chip comprising a processor and a communication interface coupled to the processor, wherein the processor is configured to execute program instructions to implement the interactive live streaming method according to the first or second aspect.

According to a ninth aspect of the embodiments of the present disclosure, there is provided a computer program, comprising: instructions that, when executed by a processor, implement the interactive live streaming method according to the first or second aspect.

According to a tenth aspect of the embodiments of the present disclosure, there is provided an interactive live streaming system, comprising: a first client and a second client, wherein the first client comprises the interactive live streaming apparatus according to the third aspect, and the second client comprises the interactive live streaming apparatus according to the fourth aspect.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the embodiments of the present invention or the technical solutions in the prior art, a brief introduction will be given below for the drawings required to be used in the description of the embodiments or the prior art. It is obvious that, for a person skilled in the art, he or she may also acquire other drawings according to such drawings on the premise that no inventive effort is involved.

FIG. 1 is a flowchart of an existing interactive live streaming method provided by some embodiments of the present disclosure;

FIG. 2 is a flowchart of an interactive live streaming method provided by some embodiments of the present disclosure;

FIG. 3 is a structural block diagram of an interactive live streaming apparatus provided by some embodiments of the present disclosure;

FIG. 4 is a structural block diagram of an interactive live streaming apparatus provided by other embodiments of the present disclosure;

FIG. 5 is a structural block diagram of an electronic device provided by some embodiments of the present disclosure.

### DETAILED DESCRIPTION

In order to better understand the above objects, features and advantages of the present disclosure, the scheme of the present disclosure will be further described below. It should be noted that, in the case of no conflict, the embodiments and the features of the embodiments of the present disclosure may be combined with each other.

Many specific details are set forth in the following description to facilitate a full understanding of the present disclosure, but the present disclosure can also be implemented in other ways different from those described herein. Obviously, embodiments described in the description are only some embodiments of the present disclosure, and are not all of embodiments thereof.

It should be noted that the terms “first”, “second” and the like in the description and claims of the present disclosure are used to distinguish similar objects, and are not necessarily used to describe a specific order or sequence. It should be understood that the terms so used may be interchanged where appropriate so that the embodiments of the disclosure described herein can be implemented in an order other than those illustrated or described herein. In addition, the objects distinguished by “first”, “second”, etc. are typically of the same type, without limitation as to the number of objects. For example, the first object may be one or more objects. In addition, in the description and claims, the word “and/or” represents at least one of the associated objects, and the character “/” generally indicates that the associated objects before and after “/” have an “or” relationship.

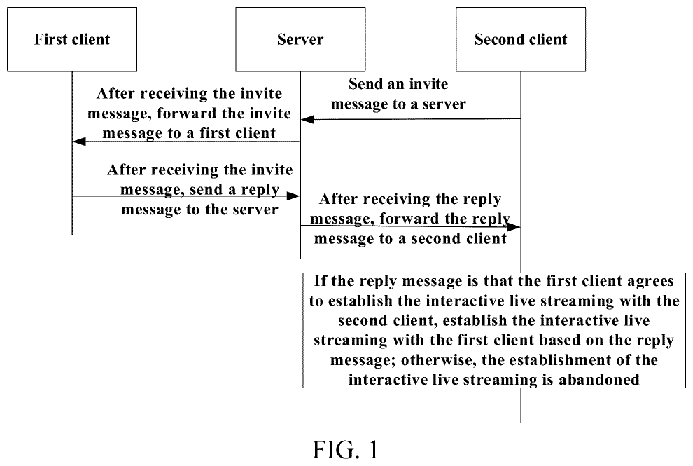

As shown in FIG. 1, in the prior art, during a process of establishing an interactive live streaming, a second client (an electronic device of anchor 1) sends an invite message to a first server (the invite message is used to invite the first client to establish the interactive live streaming); after receiving the invite message, the first server forwards the invite message to a first client (an electronic device of anchor 2); after receiving the invite message, the first client sends a reply message to the first server (the reply message is used to indicate an agreement or a refusal to establish the interactive live streaming with the second client); After the first server receives the reply message, it forwards the reply message to the second client; after the second client receives the reply message, if the reply message is that the first client agrees to establish the interactive live streaming with the second client, it establishes the interactive live streaming with the first client based on the reply message; otherwise, the establishment of the interactive live streaming is abandoned.

For example, the first server forwards messages related to live streaming services or live streaming functions to the first client and the second client, which can also be referred to as a live streaming service server, live streaming server, live streaming application (APP) server, etc.

For example, live streaming messages (comprising invite messages, reply messages, etc.) are all messages based on Hypertext Transfer Protocol (HTTP) links, which are based on the Transmission Control Protocol (TCP) protocol. Live streaming messages based on the TCP protocol have high reliability but poor timeliness.

In the current interactive live streaming mechanism, if an inviting party does not receive a response from an invited party within a valid duration of an invite message (usually 20 seconds, which can be other waiting times depending on actual situations), the interactive live streaming is canceled directly (of course, during an invite period, if the inviting party is unwilling to wait, the interactive live streaming can be canceled in advance). Therefore, it is necessary for the inviting party to wait for the time when the invite message arrives from the first client to the second client, the time when the reply message arrives from the second client to the first client, and the time when the invited party responds after the invite message is displayed on the second client (the invited party usually cannot respond immediately and need to wait for a few seconds to respond). Therefore, if there is a long delay in a transmission of the invite message or the reply message, it is likely that the reply message will not be received within the valid duration of the invite message, resulting in the interactive live streaming being canceled and ultimately the interactive live streaming failing. Especially in complex network and equipment environments (such as international network and equipment environments), it is easy to cause a high delay in the arrival time of live streaming messages (for example, live streaming messages need to pass through a central data center during the transmission, and if a distance between the central data center and other first servers is large, it will cause a significant delay in the transmission of live streaming messages), thereby reducing a successful rate of the establishment of the interactive live streaming.

In order to solve the above technical problem, in some embodiment of the present disclosure, an invite message can be received from a second client, wherein the invite message is configured to invite a first client to establish an interactive live streaming; an RTC reply message is sent to the second client according to the invite message, wherein the RTC reply message is configured to indicate agreement to establish the interactive live streaming with the second client, and is for the second client to establish the interactive live streaming with the first client according to the RTC reply message. That is, after receiving the invite message, the first client notifies the second client of its agreement to the interactive live streaming request via a low-latency RTC reply message to achieve the establishment of the interactive live streaming. By using the RTC reply message, the time required to establish the interactive live streaming can be shortened to a certain extent. Therefore, the problem of interactive live streaming failure caused by a long delay in the transmission of invite and/or reply messages can be solved, thereby improving the successful rate of the establishment of the interactive live streaming.

The electronic device in this embodiment can be a mobile electronic device or a non-mobile electronic device. The mobile electronic device may be a mobile phone, a tablet, a laptop, a handheld computer, a vehicle-mounted electronic device, a wearable device, an Ultra Mobile Personal Computer (UMPC), a netbook, or a Personal Digital Assistants (PDA), etc; the non mobile electronic device may be a Personal Computer (PC), a television (TV), an ATM, or a self-service machine, etc. This embodiment has no specific limitations thereto.

An execution entity of the interactive live streaming method provided in some embodiments of this disclosure are the first client and the second client. The first client and the second client can be the electronic devices described above (comprising the mobile electronic devices and the non-mobile electronic devices), as well as functional modules and/or functional entities that can implement the interactive live streaming method in the electronic devices, which can be determined according to actual usage needs, and are not limited in this embodiment.

Below, with reference to the accompanying drawings, a detailed explanation of the interactive live streaming method provided in some embodiments of the present disclosure will be provided with reference to specific embodiments and an application scenario.

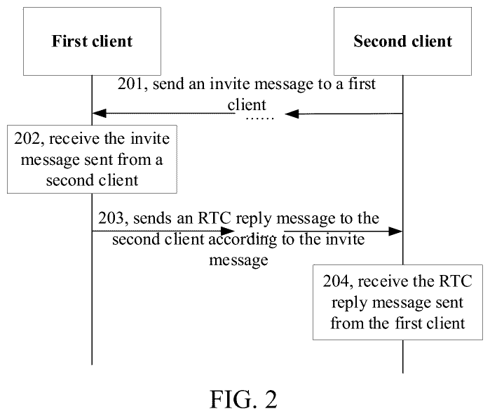

As shown in FIG. 2, some embodiments of the present disclosure provide an interactive live streaming method, which may comprise steps 201 to 204 as follows.

In step 201, a second client sends an invite message to a first client.

In some embodiments, the invite message is configured to invite the first client to establish an interactive live streaming.

It can be understood that the above step 201 specifically involves the second client sending the invite message to the first client via a first server.

In step 202, the first client receives the invite message sent from the second client.

It can be understood that the above step 202 specifically involves the first client receiving the invite message sent from the second client via the first server.

In step 203, the first client sends an RTC (Real Time Communication) reply message to the second client according to the invite message.

The RTC reply message is configured to indicate an agreement to establish the interactive live streaming with the second client, and is for the second client to establish the interactive live streaming with the first client according to the RTC reply message.

It can be understood that the above step 203 specifically involves the first client sending the RTC reply message to the second client via a second server (i.e., an RTC server) according to the invite message.

In some embodiments, the first server is different from the second server. The RTC server is a media server based on a real-time message transfer protocol, which can forward media streams between different devices and achieve a voice or video interaction between different devices. The RTC reply message is transmitted based on the User Datagram Protocol (UDP). Since there are many edge nodes on the RTC server side, the RTC reply message is transmitted faster and has a lower delay than a live streaming message.

It can be understood that before the first client sends an RTC reply message to the second client via the RTC server, the first client needs to establish an RTC connection with the RTC server. The process of establishing the RTC connection comprises a RTC initialization, a RTC “enterRoom” (allowing a user to enter a live channel), and a RTC pushing streaming, etc., for which reference can be made to existing relevant technologies, and which are not specifically limited here. At present, in the interactive live streaming mechanism, an RTC connection between the second client and the RTC server is generally established after the second client sends the invite message to the first client; after the first client receives the invite message sent from the second client, the RTC connection between the first client and the RTC server is generally established.

In some embodiments, an HTTP connection is configured to transmit upper level services, comprising a live streaming service, etc; the RTC connection is configured to transmit lower level services, comprising a service of a co-streaming of images of the interactive live streaming mechanism.

In step 204, the second client receives the RTC reply message sent by the first client.

In some embodiments, the RTC reply message is for the second client to establish the interactive live streaming with the first client according to the RTC reply message. That is, the RTC reply message serves as the basis for establishing the interactive live streaming between the second client and the first client.

It can be understood that the above step 204 specifically involves the second client receiving the RTC reply message sent from the first client via the RTC server.

In some embodiments of the present disclosure, upon receiving the invite message, the first client notifies the second client of the agreement to a request of the interactive live streaming via a low latency RTC response message to achieve the establishment of the interactive live streaming. By using the RTC reply message, the time required to establish the interactive live streaming can be shortened to a certain extent. Therefore, the problem of a failure of the interactive live streaming caused by a long delay in the transmission of the invite message and/or the reply message can be solved, thereby improving the successful rate of the establishment of the interactive live streaming.

In some embodiments, the above step 203 can be specifically implemented by the following step 203a.

In step 203a, the first client sends the RTC reply message to the second client in response to a remaining valid duration of the invite message being less than a first duration threshold.

In some embodiments, the first duration threshold can be half of a total valid duration of the invite message, or other values. The specific first duration threshold can be determined based on an actual situation and is not limited here.

In some embodiments, the remaining valid duration may be a time period between the time when the first client receives the invite message and the time when the invite message expires, i.e., the time difference between the time when the invite message expires and the time when the first client receives the invite message. The time when the invite message expires can be calculated by the second client based on a sending time of the invite message and the total valid duration of the invite message, and is carried in the invite message. The time when the invite message expires can also be calculated by a server based on the time of receiving the invite message and the total valid duration of the invite message, or by the server based on the time of receiving the invite message, a first preset duration, and the total valid duration of the invite message, wherein the first preset duration is an average time from sending the invite message from the second client to the server to receiving the invite message, as determined by statistics. The time when the invite message expires can also be calculated by the first client based on the sending time of the invite message and the total valid duration of the invite message. In this case, the sending time of the invite message is carried in the invite message, and the total valid duration of the invite message can be stored in the first client or carried in the invite message.

In some embodiments, the remaining valid duration is a first difference between the time when the invite message expires and the time when the server sends the invite message (or a difference between the first difference and a second preset time, and the second preset time is an average time from the server sending the invite message to the first client receiving the invite message, which is determined by statistics). Both the time when the invite message expires and the time when the server sends the invite message are carried in the invite message sent by the server to the first client. In this case, time of the server is used as a reference to avoid a problem of inaccurate calculation of the remaining valid duration due to inconsistent times between the first client and the second client.

In some embodiments, the time when the invite message expires is calculated by the server based on the time of receiving the invite message and the total valid duration of the invite message, or by the server based on the time of receiving the invite message, a first preset duration, and the total valid duration of the invite message. The first preset duration is an average time from the second client sending the invite message to the server receiving the invite message, as determined by statistics.

In the embodiments, multiple methods for calculating the remaining valid duration are provided, which can be determined based on actual situations and are not limited here.

In the embodiments, if the remaining valid duration is less than the first duration threshold, it is likely that the second client cannot receive the HTTP reply message sent by the first client within the total valid duration of the invite message. Therefore, if the remaining valid duration of the invite message is less than the first duration threshold, the first client can send the RTC reply message to the second client to improve the efficiency of the second client in receiving the reply message and thereby improve the successful rate of the establishment of the interactive live streaming.

In some embodiments, the above step 203 can be specifically implemented by the following step 203b. After step 203b, the interactive live streaming method provided in some embodiments of the present disclosure may further comprise steps 205 to 206 as follows.

In step 203b, the first client sends the RTC reply message and a HTTP reply message to the second client according to the invite message, so that the second client can establish the interactive live streaming with the first client based on a target reply message.

In some embodiments, the target reply message is one of the RTC reply message and the HTTP reply message received first by the second client. That is, if a receiving time of the RTC reply message is earlier than that of the HTTP reply message, the target reply message is the RTC reply message; if the receiving time of the HTTP reply message is earlier than that of the RTC reply message, the target reply message is the HTTP reply message.

It can be understood that if the second client receives the RTC reply message first, the second client establishes the interactive live streaming with the first client based on the RTC reply message. During a process of establishing the interactive live streaming between the second client and the first client, or after the second client completes establishing the interactive live streaming with the first client, if the second client receives the HTTP reply message, the HTTP message is ignored.

It can be understood that if the second client receives the HTTP reply message first, the second client establishes the interactive live streaming with the first client based on the HTTP reply message. During the process of establishing the interactive live streaming between the second client and the first client, or after the second client completes establishing the interactive live streaming with the first client, if the second client receives the RTC reply message, the RTC message is ignored.

In some embodiments, the HTTP reply message is configured to indicate an agreement to establish the interactive live streaming with the second client.

It can be understood that the above step 203b specifically involves the first client sending the HTTP reply message to the second client via the first server based on the invite message, and the first client sending the RTC reply message to the second client via the second server based on the invite message.

In some embodiments, the first client may simultaneously send the RTC reply message and the HTTP reply message to the second client. The first client may also send the RTC reply message and the HTTP reply message to the second client at different times depending on actual situations, which is not specifically limited herein.

In step 205, the second client receives the HTTP reply message sent by the first client.

It can be understood that the above step 206 specifically involves the second client receiving the HTTP reply message sent from the first client via the first server.

In step 206, the second client establishes the interactive live streaming with the first client based on the target reply message.

In the embodiments, when the first client sends the RTC reply message to the second client, the first client also sends the HTTP reply message to the second client as a supplement of the RTC reply message. By using two forms of reply messages, a reliability of a reply event can be improved, ensuring that the second client can receive the reply message as soon as possible, thereby improving the successful rate of the establishment of the interactive live streaming.

In some embodiments, the above step 203b may comprise the following step 203b1, and the above step 203b may also comprise the following steps 203b2 or 203b3.

In step 203b1, the first client sends an HTTP reply message to the second client according to the invite message when the remaining valid duration is greater than or equal to a second duration threshold.

It can be understood that the above step 203b1 specifically involves the first client sending the HTTP reply message to the second client via the first server when the remaining valid duration is greater than or equal to the second duration threshold.

In step 203b2, the first client sends the RTC reply message to the second client according to the invite message.

In step 203b3, the first client sends the RTC reply message to the second client, in response to the remaining valid duration of the invite message being less than the first duration threshold.

In some embodiments, the HTTP reply message is configured to indicate an agreement to establish the interactive live streaming with the second client.

For the description of the remaining valid duration, reference can be made to the relevant description of the remaining valid duration in step 203a above, which will not be repeated here.

For the description of the second duration threshold, reference can be made to the relevant description of the first duration threshold in step 203a above, which will not be repeated here.

The second duration threshold may be the same as or different from the first duration threshold, which can be determined according to actual situations and is not limited here. For the case of 203b3 mentioned above, the first duration threshold and the second duration threshold are the same.

In the embodiments, if the remaining valid duration is greater than or equal to the second duration threshold, the probability of the second client receiving the HTTP reply message sent from the first client is relatively high. Therefore, the first client can send the HTTP reply message to the second client as a supplement to the RTC reply message, so as to improve a reliability of a reply event through two forms of reply messages, ensuring that the second client can receive the reply message as soon as possible, and thereby improving the successful rate of the establishment of the interactive live streaming.

In some embodiments, the above step 206 can be specifically implemented by the following step 206a or 206b.

In step 206a, in response to receiving the RTC reply message and not establishing the interactive live streaming with the first client, the second client establishes the interactive live streaming with the first client according to the HTTP reply message.

In step 206b, in response to receiving the HTTP reply message and not establishing the interactive live streaming with the first client, the second client establishes the interactive live streaming with the first client according to the RTC reply message.

It can be understood that in the embodiments, because the first client can send the HTTP reply message and the RTC reply message after receiving the invite message, if the second client receives the HTTP reply message first, the interactive live streaming is established with the first client based on the HTTP reply message. If the second client receives the RTC reply message first, the interactive live streaming is established with the first client based on the RTC reply message. In this way, it can ensure that the interactive live streaming can be quickly established between the second client and the first client, thereby reducing a probability of a failure of the interactive live streaming due to a long delay of the reply message, and improving the user experience.

It can be understood that, based on the description of the above embodiments, in the embodiments of the present disclosure, after the first client receives the invite message sent from the second client, the first client can only send the RTC reply message to the second client. Or the first client can send the RTC reply message and the HTTP reply message to the second client. Or the first client can send the HTTP reply message to the second client (in this case, the HTTP reply message is sent, regardless of the remaining valid duration limit; that is, as long as the invite message is received, the HTTP reply message is sent), and when the remaining valid duration is less than the first duration threshold, the RTC reply message is sent to the second client. Or the first client can send the RTC reply message to the second client (in this case, the RTC reply message is sent, regardless of the remaining valid duration limit; that is, as long as the invite message is received, the RTC reply message is sent), and when the remaining valid duration is greater than or equal to the second duration threshold, the HTTP reply message is sent to the second client. Or the first client can send the RTC reply message to the second client when the remaining valid duration is less than the first duration threshold, and send the HTTP reply message to the second client when the remaining valid duration is greater than or equal to the second duration threshold (in this case, the first duration threshold and the second duration threshold are the same). The specific details can be determined based on actual situations, and are not specifically limited in this embodiment.

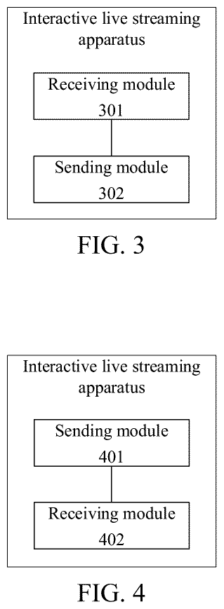

FIG. 3 is a structural block diagram of an interactive live streaming apparatus provided by some embodiments of the present disclosure. As shown in FIG. 3, the interactive live streaming apparatus comprises: a receiving module 301 and a sending module 302. The receiving module 301 is configured to receive an invite message sent from a second client, wherein the invite message is configured to invite the first client to establish an interactive live streaming; and the sending module 302 is configured to send a Real Time Communication (RTC) reply message to the second client according to the invite message, wherein the RTC reply message is configured to indicate an agreement to establish the interactive live streaming with the second client, and is for the second client to establish the interactive live streaming with the first client according to the RTC reply message.

In some embodiments, the sending module 302 is configured to send the RTC reply message to the second client in response to a remaining valid duration of the invite message being less than a first duration threshold.

In some embodiments, the sending module 302 is particularly configured to send the RTC reply message and a Hypertext Transfer Protocol (HTTP) reply message to the second client according to the invite message, to enable the second client to establish an interactive live streaming with the first client based on a target reply message, wherein the target reply message is one of the RTC reply message and the HTTP reply message received first by the second client, and the HTTP reply message is configured to indicate the agreement to establish the interactive live streaming with the second client.

In some embodiments, the sending module 302 is particularly configured to send the HTTP reply message to the second client in response to a remaining valid duration of the invite message is greater than or equal to a second duration threshold. The HTTP reply message is configured to indicate the agreement to establish the interactive live streaming with the second client.

The various modules in the embodiments can implement the interactive live streaming method provided in the above method embodiment, and can achieve the same technical effect, which will not be repeated here to avoid repetition.

FIG. 4 is a structural block diagram of an interactive live streaming apparatus provided by some embodiments of the present disclosure. As shown in FIG. 4, the interactive live streaming apparatus comprises: a sending module 401 and a receiving module 402. The sending module 401 is configured to send an invite message to a first client, wherein the invite message is configured to invite the first client to establish an interactive live streaming; and the receiving module 402 is configured to receive a Real Time Communication (RTC) reply message sent from the first client, wherein the RTC reply message is for the second client to establish the interactive live streaming with the first client according to the RTC reply message, and is configure to indicate that the first client agrees to establish the interactive live streaming with the second client.

In some embodiments, the receiving module 402 is further configure to receive a Hypertext Transfer Protocol (HTTP) reply message sent from the first client, after sending the invite message to the first client.

In some embodiments, the apparatus further comprises an establishment module. The establishment module is configured to establish the interactive live streaming with the first client according to the RTC reply message, in response to receiving the RTC reply message and not establishing the interactive live streaming with the first client.

In some embodiments, the apparatus further comprises an establishment module. The establishment module is configured to establish the interactive live streaming with the first client based on the HTTP reply message, in response to receiving the HTTP reply message and not establishing the interactive live streaming with the first client.

The various modules in the embodiments can implement the interactive live streaming method provided in the above method embodiments, and can achieve the same technical effect, which will not be repeated here to avoid repetition.

The present disclosure further provides an interactive live streaming system, comprising: a first client and a second client, wherein the first client comprises the interactive live streaming apparatus provided by the embodiments shown in FIG. 3, and the second client comprises the interactive live streaming apparatus provided by the embodiments shown in FIG. 4.

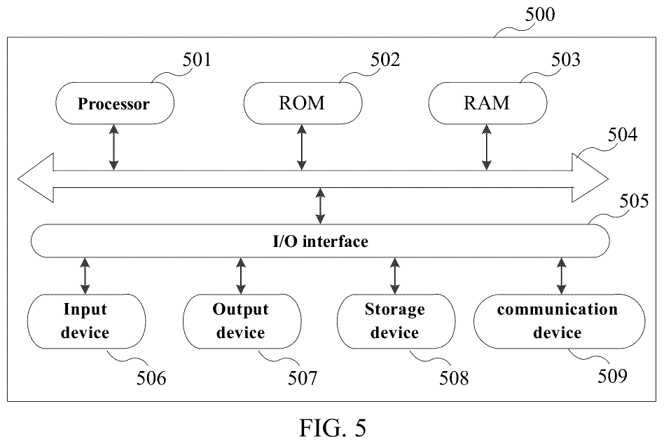

FIG. 5 is a schematic structure diagram of an electronic device provided by an embodiment of the present disclosure, for illustrating the electronic device implementing the interactive live streaming method provided by any embodiment of the present disclosure, and should not be understood as a specific limitation of the embodiments of the present disclosure.

As shown in FIG. 5, the electronic device 500 may comprise a processor (e.g., a central processing unit, a graphics processor) 501, which may perform various appropriate actions and processes according to a program stored in Read Only Memory (ROM) 502 or a program loaded from storage device 508 into Random Access Memory (RAM) 503. In RAM 503, various programs and data required for the operation of the electronic device 500 are also stored. The processor 501, ROM 502, and RAM 503 are connected to each other through a bus 504. An input/output (I/O) interface 505 is also connected to the bus 504.

Generally, the following devices can be connected to I/O interface 505: input devices 506 comprising, for example, a touch screen, a touch pad, a keyboard, a mouse, a camera, a microphone, an accelerometer, a gyroscope, etc; output devices 507 comprising a liquid crystal display (LCD), a speaker, a vibrator, etc.; a storage device 508 such as a magnetic tape, a hard disk, etc; and a communication device 509. The communication device 509 enables the electronic device 500 to communicate in a wireless or wired manner with other devices to exchange data. Although FIG. 5 shows the electronic device 500 with various components, it should be understood that it is not required to implement or have all of these components. Alternatively, more or fewer components can be implemented or provided.

In particular, according to an embodiment of the present disclosure, the processes described above with reference to the flowchart can be implemented as a computer software program. For example, an embodiment of the present disclosure comprises a computer program product, which comprises a computer program carried on a non-transitory computer readable medium, and containing program code for executing the method shown in the flowchart. In such an embodiment, the computer program may be downloaded and installed from the network through the communication device 509, or installed from the storage device 508, or from the ROM 502. When the computer program is executed by the processor 501, the above functions defined in the interactive live streaming method provided by any embodiment of the present disclosure are performed.

The present disclosure further provides a computer program, comprising: instructions that, when executed by a processor, cause the processor to the implement the interactive live streaming method according to any embodiments described above.

It should be noted that the computer readable medium in the present disclosure may be a computer readable signal medium or a computer readable storage medium, or any combination of thereof. The computer readable storage medium can be, for example, but not limited to, an electronic, magnetic, optical, electromagnetic, infrared, or semiconductor system, apparatus, or device, or any combination of the above. More specific examples of the computer readable storage medium may comprise, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may comprise a data signal that is propagated in the baseband or as part of a carrier, carrying computer readable program code. Such propagated data signals can take a variety of forms comprising, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, comprising but not limited to wire, fiber optic cable, RF (radio frequency), etc., or any suitable combination of the foregoing.

In some embodiments, a client and a server can communicate using any currently known or future developed network protocol such as HTTP (HyperText Transfer Protocol), and can be interconnected by any form or medium of digital data communication, e.g., a communication network. Examples of communication networks comprise a local area network (“LAN”) and a wide area network (“WAN”), the Internet, and end-to-end networks (for example, ad hoc end-to-end networks), as well as any currently known or future developed networks.

The above computer readable medium may be comprised in the electronic device described above; or it may exist alone without being assembled into the electronic device.

The computer readable medium carries one or more programs that, when executed by the electronic device (which is a first client), cause the electronic device to perform steps of: receiving an invite message sent from a second client, wherein the invite message is configured to invite the first client to establish an interactive live streaming; and sending a Real Time Communication (RTC) reply message to the second client according to the invite message, wherein the RTC reply message is configured to indicate an agreement to establish the interactive live streaming with the second client, and is for the second client to establish the interactive live streaming with the first client according to the RTC reply message.

Alternatively, the computer readable medium carries one or more programs that, when executed by the electronic device (which is a second client), cause the electronic device to perform steps of: sending an invite message to a first client, wherein the invite message is configured to invite the first client to establish an interactive live streaming; and receiving a Real Time Communication (RTC) reply message sent from the first client, wherein the RTC reply message is for the second client to establish the interactive live streaming with the first client according to the RTC reply message, and is configure to indicate that the first client agrees to establish the interactive live streaming with the second client.

In the present disclosure, computer program code for executing operations of the present disclosure may be complied by any combination of one or more program design languages, the program design languages comprising, but not limited to, object-oriented program design languages, such as Java, Smalltalk, C++, etc, as well as conventional procedural program design languages, such as “C” program design language or similar program design language. The program code may be completely or partly executed on a computer, or executed as an independent software package, partly executed on the computer and partly executed on a remote computer, or completely executed on a remote computer or server. In the latter circumstance, the remote computer may be connected to a computer through various kinds of networks, comprising local area network (LAN) or wide area network (WAN), or connected to an external computer (for example using an Internet service provider via the Internet).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the drawings. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments described in the present disclosure can be implemented in software or hardware. Wherein, the names of the units do not constitute a limitation on the units themselves under certain circumstances.

The functions described above may be performed at least in part by one or more hardware logic components. For example, without limitation, exemplary types of hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD), etc.

In the context of the present disclosure, a computer-readable medium may be a tangible medium, which may contain or store a program for use by or in connection with an instruction execution system, apparatus, or device. The computer readable medium can be a computer readable signal medium or a computer readable storage medium. The computer readable medium may comprise, but is not limited to, an electronic, magnetic, optical, electromagnetic, infrared, or semiconductor system, apparatus, or device, or any suitable combination of thereof. More specific examples of the computer readable storage medium may comprise electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing.

The above description is only preferred embodiments of the present disclosure and an explanation of the applied technical principles. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are comprised in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable subcombination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. An interactive live streaming method applicable to a first client, comprising:
receiving an invite message sent from a second client, wherein the invite message is configured to invite the first client to establish an interactive live streaming; and
sending a Real Time Communication (RTC) reply message to the second client according to the invite message, wherein the RTC reply message is configured to indicate an agreement to establish the interactive live streaming with the second client, and is for the second client to establish the interactive live streaming with the first client according to the RTC reply message.

2. The interactive live streaming method according to claim 1, wherein the sending the RTC reply message to the second client according to the invite message comprises:
sending the RTC reply message to the second client in response to a remaining valid duration of the invite message being less than a first duration threshold.

3. The interactive live streaming method according to claim 1, wherein the sending the RTC reply message to the second client according to the invite message comprises:
sending the RTC reply message and a Hypertext Transfer Protocol (HTTP) reply message to the second client according to the invite message, to enable the second client to establish an interactive live streaming with the first client based on a target reply message,
wherein the target reply message is one of the RTC reply message and the HTTP reply message received first by the second client, and the HTTP reply message is configured to indicate the agreement to establish the interactive live streaming with the second client.

4. The interactive live streaming method according to claim 3, wherein the sending the HTTP reply message to the second client according to the invite message comprises:
sending the HTTP reply message to the second client in response to a remaining valid duration of the invite message is greater than or equal to a second duration threshold.

5. The interactive live streaming method according to claim 1, wherein:
the receiving the invite message sent from the second client comprises,
receiving the invite message sent from the second client via a first server; and
the sending the RTC reply message to the second client comprises,
sending the RTC reply message to the second client via a second server, wherein the first server is different from the second server, and the second server is an RTC server.

6. A interactive live streaming method applicable to a second client, comprising:
sending an invite message to a first client, wherein the invite message is configured to invite the first client to establish an interactive live streaming; and
receiving a Real Time Communication (RTC) reply message sent from the first client, wherein the RTC reply message is for the second client to establish the interactive live streaming with the first client according to the RTC reply message, and is configure to indicate that the first client agrees to establish the interactive live streaming with the second client.

7. The interactive live streaming method according to claim 6, further comprising, after sending the invite message to the first client:
receiving a Hypertext Transfer Protocol (HTTP) reply message sent from the first client.

8. The interactive live streaming method according to claim 7, further comprising, after sending the invite message to the first client:
in response to receiving the RTC reply message and not establishing the interactive live streaming with the first client, establishing the interactive live streaming with the first client according to the RTC reply message; or
in response to receiving the HTTP reply message and not establishing the interactive live streaming with the first client, establishing the interactive live streaming with the first client based on the HTTP reply message.

9. The interactive live streaming method according to claim 6, wherein:
the sending the invite message to the first client comprises,
sending the invite message to the first client via a first server; and
the receiving the RTC reply message sent from the first client comprises,
receiving the RTC reply message sent from the first client via a second server, wherein the first server is different from the second server, and the second server is an RTC server.

10-11. (canceled)

12. An electronic device, comprising: a memory and a processor, wherein the memory is configured to store computer programs and by invoking the computer programs, the processor is configured to:
receive an invite message sent from a second client, wherein the invite message is configured to invite the first client to establish an interactive live streaming; and
send a Real Time Communication (RTC) reply message to the second client according to the invite message, wherein the RTC reply message is configured to indicate an agreement to establish the interactive live streaming with the second client, and is for the second client to establish the interactive live streaming with the first client according to the RTC reply message.

13. A non-transitory computer readable storage medium stored thereon computer programs that, when executed by a processor, cause the processor to implement the interactive live streaming method according to claim 1.

14-15. (canceled)

16. An interactive live streaming system, comprising: a first client and a second client, wherein the first client is configured to execute the interactive live streaming method according to claim 1, and the second client, wherein the second client comprises a processor; and a memory coupled to the processor, for storing instructions which when executed by the processor, cause the processor to:
send an invite message to a first client, wherein the invite message is configured to invite the first client to establish an interactive live streaming; and
receive a Real Time Communication (RTC) reply message sent from the first client, wherein the RTC reply message is for the second client to establish the interactive live streaming with the first client according to the RTC reply message, and is configured to indicate that the first client agrees to establish the interactive live streaming with the second client.

17. The electronic device according to claim 13, wherein the sending the RTC reply message to the second client according to the invite message comprises:
sending the RTC reply message to the second client in response to a remaining valid duration of the invite message being less than a first duration threshold.

18. The electronic device according to claim 13, wherein the sending the RTC reply message to the second client according to the invite message comprises:
sending the RTC reply message and a Hypertext Transfer Protocol (HTTP) reply message to the second client according to the invite message, to enable the second client to establish an interactive live streaming with the first client based on a target reply message,
wherein the target reply message is one of the RTC reply message and the HTTP reply message received first by the second client, and the HTTP reply message is configured to indicate the agreement to establish the interactive live streaming with the second client.

19. The electronic device according to claim 18, wherein the sending the HTTP reply message to the second client according to the invite message comprises:
sending the HTTP reply message to the second client in response to a remaining valid duration of the invite message is greater than or equal to a second duration threshold.

20. The electronic device according to claim 13, wherein:
the receiving the invite message sent from the second client comprises,
receiving the invite message sent from the second client via a first server; and
the sending the RTC reply message to the second client comprises,
sending the RTC reply message to the second client via a second server, wherein the first server is different from the second server, and the second server is an RTC server.

21. An electronic device, comprising: a memory and a processor, wherein the memory is configured to store computer programs, which when executed by the processor, cause the processor to perform the interactive live streaming according to claim 6.

22. The electronic device according to claim 21, wherein the computer programs, which when executed by the processor, further causes the processor to, after sending the invite message to the first client:
receive a Hypertext Transfer Protocol (HTTP) reply message sent from the first client.

23. The electronic device according to claim 22, wherein the computer programs, which when executed by the processor, further causes the processor to, after sending the invite message to the first client:
in response to receiving the RTC reply message and not establishing the interactive live streaming with the first client, establishing the interactive live streaming with the first client according to the RTC reply message; or
in response to receiving the HTTP reply message and not establishing the interactive live streaming with the first client, establishing the interactive live streaming with the first client based on the HTTP reply message.

24. The electronic device according to claim 21, wherein:
the sending the invite message to the first client comprises,
sending the invite message to the first client via a first server; and
the receiving the RTC reply message sent from the first client comprises,
receiving the RTC reply message sent from the first client via a second server, wherein the first server is different from the second server, and the second server is an RTC server.
